(19) United States
(12) Patent Application Publication
(10) Pub. No.: US 2024/0070939 A1
(43) Pub. Date: Feb. 29, 2024

(54) DETERMINING A RELATIONSHIP BETWEEN POINTS-OF-INTEREST (POI) AND PARKING LOTS

(71) Applicant: SafeGraph, Inc., San Francisco, CA (US)

(72) Inventors: Ryan Davis, Mobile, AL (US); Eugene Chong, Somerville, MA (US)

(73) Assignee: SafeGraph, Inc., San Francisco, CA (US)

(21) Appl. No.: 18/092,231

(22) Filed: Dec. 31, 2022

Related U.S. Application Data
(60) Provisional application No. 63/402,937, filed on Aug. 31, 2022.

(51) Int. Cl. G06T 11/20; G06Q 10/0635; G06V 20/10

(52) U.S. Cl. CPC G06T 11/203; G06Q 10/0635; G06V 20/176

(57) ABSTRACT

In some aspects, a server determines a plurality of parking lots in aerial data. The plurality of parking lots is identified by a plurality of two-dimensional polygons that correspond to the plurality of parking lots and are superimposed on aerial images in the aerial data. The server simplifies a geometry of the plurality of two-dimensional polygons to create parking lot data, determines point-of-interest data associated multiple points of interest, determines correlation data that includes a relationship between: a particular point-of-interest in the point-of-interest data and a set of one or more parking lots in the parking lot data, and sends the correlation data to a client device.

### CROSS-REFERENCE TO RELATED APPLICATIONS

The present non-provisional patent application is a continuation of U.S. Provisional Application 63,402,937 which was filed on Aug. 31, 2022 and which is incorporated by reference in its entirety and for all purposes as if completely and fully set forth herein.

### BACKGROUND OF THE INVENTION

### Field of the Invention

This invention relates generally to systems to correlating individual points-of-interest (POI) with one or more parking lots (e.g., this POI is most likely serviced by these parking lots) to determine a relationship between the individual POIs and the one or more parking lots.

### Description of the Related Art

Points-of-interest (POI) data includes information about physical locations, such as retail stores, shopping malls, and other locations that attract potential customers. POI data is useful for business and competitive intelligence analysis and may be used by investors, retail businesses, and the like. Maintaining up-to-date information POI data is challenging because the retail landscape can change quickly. A further challenge is correlating POI data with parking lot information to understand which parking lots are serving which POIs.

### SUMMARY OF THE INVENTION

This Summary provides a simplified form of concepts that are further described below in the Detailed Description. This Summary is not intended to identify key or essential features and should therefore not be used for determining or limiting the scope of the claimed subject matter.

In some aspects, a server determines a plurality of parking lots in aerial data. The plurality of parking lots is identified by a plurality of two-dimensional polygons that correspond to the plurality of parking lots and are superimposed on aerial images in the aerial data. The server simplifies a geometry of the plurality of two-dimensional polygons to create parking lot data, determines point-of-interest data associated multiple points of interest, determines correlation data that includes a relationship between: a particular point-of-interest in the point-of-interest data and a set of one or more parking lots in the parking lot data, and sends the correlation data to a client device.

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIG. 1 is a block diagram of a system to correlate individual parking lots with points-of-interest (POI), according to some embodiments.

FIG. 2 is a diagram illustrating a parking lot size distribution graph, according to some embodiments, according to some embodiments.

FIG. 3 is a block diagram illustrating identifying and removing particular holes from a parking lot.

FIG. 4 is a block diagram illustrating smoothing an outline of a parking lot, according to some embodiments.

FIG. 5 is a block diagram illustrating parking lots serving more than one point-of-interest (POI), according to some embodiments.

FIG. 6 is a flowchart of a process that includes correlating parking lot data with points-of-interest data, according to some embodiments.

FIG. 7 is a flowchart of a process that includes filtering parking lot data, according to some embodiments.

FIG. 8 is a flowchart of a process that includes determining a relationship between individual points-of-interest (POIs) to one or more parking lots, according to some embodiments.

FIG. 9 is a flowchart of a process to train a machine learning algorithm to create an artificial intelligence (AI), according to some embodiments.

FIG. 10 illustrates an example configuration of a computing device that can be used to implement the systems and techniques described herein.

### DETAILED DESCRIPTION

The systems and techniques described herein correlate parking lot data with point-of-interest (POI) data to determine which one or more parking lots people use when visiting a particular POI. If a particular POI includes additional POIs (referred to herein as “tenants”), then the systems and techniques correlate the additional POIs with the one or more parking lots associated with the particular POI. For example, a shopping mall may be a POI and may include multiple tenants (e.g., individual stores) that are additional POIs. As another example, a park may be a POI and may include multiple additional POIs, such as, a playground, a statue (or other memorial), a water feature (e.g., fountain), a viewing area (e.g., to view a landmark or a scenic view), and the like. In these examples, the parking lot(s) determined to service a particular POI are likely used to service the additional POIs that are in close proximity to the particular POI.

A server may receive annotated aerial data in which aerial data captured by aerial capture devices, such as satellites, unmanned aerial vehicles (drones), and the like. The annotations in the aerial data may include parking lots that have been crudely outlined (e.g., typically by fitting a two-dimensional (2D) polygon to the parking lot). The systems and techniques may refine the parking lots data using multiple techniques to create representative parking lot data that more accurately represents individual parking lots than the crude outlines in the annotated aerial data.

The correlated data that includes relationships between POIs and parking lots may be provided to clients. For example, the correlated data may be used for (1) urban planning (e.g., to determine if there is enough parking to support consumer traffic and POIs in a particular area), (2) site selection (e.g., determine whether a site is suitable based on the presence or absence of parking lots in the vicinity of the site), (3) mapping (e.g., enhance maps to include parking lots and highlight accessibility to POIs from the parking lots), (4) risk assessment (e.g., identify surfaces, such as parking lots, in an area and determine how the surfaces may contribute to flooding and other hazards), and other purposes related to parking lots and POIs.

As an example, a server includes one or more processors and a non-transitory memory device to store instructions executable by the one or more processors to perform various operations. The operations include determining a plurality of parking lots in aerial data. Each parking lot in the plurality of parking lots is identified by a two-dimensional polygon that is superimposed on an aerial image in the aerial data. The operations include simplifying a geometry of the plurality of two-dimensional polygons to create parking lot data. The operations include determining point-of-interest data associated multiple points of interest. The operations include determining correlation data that includes a relationship between: (1) a particular point-of-interest in the point-of-interest data and (2) a set of one or more parking lots in the parking lot data. The operations include sending the correlation data to a client device to enable the client device to perform, for example, urban planning, site selection, mapping, risk assessment, or any combination thereof. The operations may include determining that the particular point-of-interest is associated with multiple tenants. The operations may include adding additional correlation data to the correlation data that includes a relationship between: the multiple tenants and the set of one or more parking lots associated with the particular point-of-interest. The correlation data identifies the set of one or more parking lots in the parking lot data that are within a threshold distance from the particular point-of-interest in the point-of-interest data. Simplifying the geometry of the plurality of two-dimensional polygons may include determining a particular two-dimensional polygon of the plurality of two-dimensional polygons that is fitted to a parking lot boundary, identifying one or more jagged lines of the particular two-dimensional polygon, and replacing individual jagged lines of the one or more jagged lines with a straight line drawn between a pair of edge endpoints of each jagged line. The operations may include determining that a particular polygon of the plurality of two-dimensional polygons includes a hole, determining an area of the hole based on a length of the hole and a width of the hole, and based on determining that the area of the hole is less than or equal to a threshold area, removing the hole from the particular polygon. Based on an analysis of the parking lot data, the operations may include determining that a plurality of small parking lots in the parking lot data that are in close proximity to each other form part of a large parking lot, merging individual two-dimensional polygons corresponding to individual small parking lots in the plurality of small parking lots to create the large parking lot, adding the large parking lot to the parking lot data, and removing the plurality of small parking lots from the parking lot data. Based on an analysis of the parking lot data, the operations may include determining that a large parking lot in the parking lot data comprises a plurality of small parking lots, separating the large parking lot into the plurality of small parking lots, removing the large parking lot from the parking lot data, and adding the plurality of small parking lots to the parking lot data.

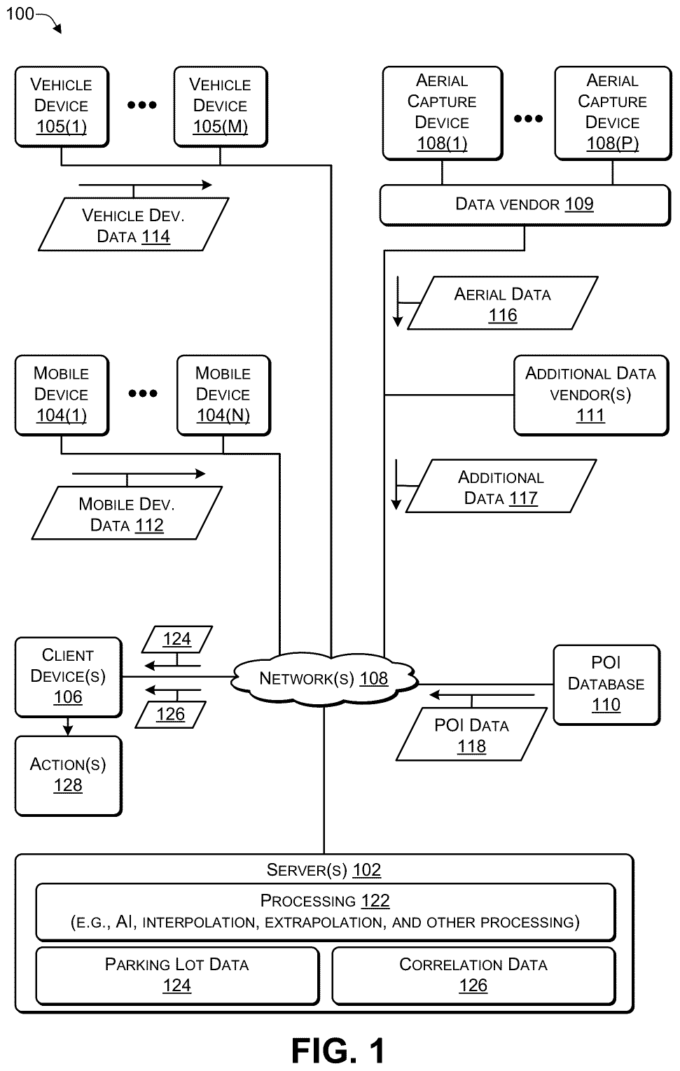

FIG. 1 is a block diagram of a system to correlate individual parking lots with points-of-interest (POI), according to some embodiments. The system 100 includes at least one server 102 connected, via a network 108, to one or more client devices 106 and a data vendor 109. In some cases, multiple aerial capture devices 108(1) to 108(P) (P>0), and a points-of-interest (POI) database 110. Additional data vendors 111 may provide additional data to the servers 102. In some cases, the client devices 106 may receive data from multiple mobile devices 104(1) to 104(N) (N>0), from multiple vehicle devices 105(1) to 105(M) (M>0), or both.

The mobile devices 104 may include smart phones, tablets, and other devices that a user may carry. The mobile devices 104 may be configured to periodically (e.g., at a predetermined time interval) or in response to detecting a particular event (e.g., device power-up or power-down) provide mobile device data 112 that includes a current location of the individual mobile devices 104. The vehicle devices 105 may include computing devices that have been integrated into vehicles (e.g., cars, trucks, sport utility vehicles (SUVs), and the like). For example, the vehicle device 105(M) may be included in an infotainment system, a navigation system, or another system that connects to an automotive bus, such as a Controller Area Network (CAN), a Media Oriented Systems Transport (MOST), or the like, of a vehicle. The vehicle devices 105 may be configured to periodically (e.g., at a predetermined time interval) or in response to detecting a particular event (e.g., device power-up or power-down) provide vehicle device data 114 that includes a current location of the individual vehicle devices 105.

The aerial capture devices 108 may include satellites, unmanned aerial vehicles (also known as drones), other types of airborne devices capable of capturing image data, or any combination thereof. The aerial capture devices 108 may provide aerial images and location information to the data vendor 109. The location information may include latitude and longitude information (i) superimposed on the aerial information, (ii) included in metadata associated with each aerial image, or the like. The location information may include geographic information such as a country, state, county, city, neighborhood, other location information or any combination thereof associated with each aerial image. The data vendor 109 may process the aerial images and provide aerial data 116 that includes coarse information regarding parking lots in the aerial data 116 to the server 102. For example, the data vendor may fit a two-dimensional (2D) polygon (or other geometric shape) to each parking lot that the data vendor 109 identifies in the aerial images from the aerial capture devices 108 and provide, to the server 102, the aerial data 116 that includes aerial images annotated with 2D polygons identifying parking lots.

The client devices 106 may include client computing devices and/or servers used by a client of a service provider associated with the server 102. The client devices 106 may perform an analysis of the mobile device data 112, the vehicle device data 114, the aerial data 116, or any combination thereof. The client devices 106 may use the analysis to perform various actions 128. For example, the actions 128 may include (1) urban planning (e.g., to determine if there is enough parking to support consumer traffic and/or additional POIs in a particular area), (2) site selection (e.g., determine whether a site is suitable for a POI based on the presence or absence of parking lots in the vicinity of the site), (3) mapping (e.g., enhance maps to include parking lots and highlight accessibility to POIs from the parking lots), (4) risk assessment (e.g., identify surfaces, such as parking lots, in an area and determine how the surfaces may contribute to flooding and other hazards), another purpose, or any combination thereof.

The POI database 110 may provide POI data 118 that includes information about points of interest. The POI data 118 may be updated periodically, such as every week or every month, to provide relatively current POI information. For example, a company that uses POI information for trade area analysis may desire that the POI information be up to date to avoid using incorrect competitor locations and misallocating resources based on stale (e.g., outdated) data. A consumer-facing mapping application may desire up to date POI data to avoid using outdated POI data that could result in a poor customer experience and a high churn rate.

The POI data 118 may include retail locations, parks, warehouses, electric vehicle (EV) charging stations, oil rigs, and other non-traditional places that are potentially of interest. In some cases, the server 102 may specify the types (e.g., retailers, warehouses, parks, warehouses, or the like) of points of interest that are to be included in the POI data 118 and what types of point of interest are to be excluded (e.g., single family homes, apartment buildings, or the like). For example, an oil company may request POI data 118 that includes gas stations, oil rigs, pipelines, refineries, and other oil-related locations that are of interest to the oil company while excluding EV charging stations and other locations that are not of interest to the oil company. Where applicable, the POI data 118 may include brand information, e.g., such as the brand name of a retailer (e.g., Target®, Old Navy® or the like), brands that a retailer sells (e.g., Nike®, Rubbermaid®, or the like), and other brand-related information. The POI data 118 may be provided using a single unified data schema to enable the data to be easily processed (e.g., without performing additional processing).

The server 102 may include one or more software programs, such as a processing module 122. The processing module 122 may perform interpolation, extrapolation, correlation, and other processing, as described herein, to the aerial data 116 and the POI data 118. In some cases, the processing module 122 may use artificial intelligence (AI) to perform one or more of the functions described herein. The server 102 may receive and perform processing 122 of the aerial data 116 to create parking lot data 124 that includes information about each parking lot identified in the aerial data 116, such as (1) a location of each parking lot, including street address, names of streets bordering each parking lot, city, region, postal code, and international standards organization (ISO) country code, (2) a number of parking spots in each parking lot, (3) how people engage with the parking lot, including phone number, website, open hours, average occupancy, seasonal occupancy, (3) how people access each parking lot, or any combination thereof. The analysis of the aerial data 116 may be performed by the processing module 122.

In addition to receiving the aerial data 116, in some cases, the server 102 may receive additional parking lot data 117 from additional data vendors 111. For example, individual parking lot owners may share information about the parking lots that each parking lot owner manages. As another example, other aerial data providers may provide additional aerial data in which parking lots are identified. The server 102 may correlate the aerial data 116 with the additional data 117 to improve an accuracy of the parking lot data 124. In some cases, the server 102 may use the additional data 117 to incorporate additional geographic features such as building outlines, roadways, and the like to increase an accuracy of individual parking lots in the parking lot data 124.

The processing 122 may be used to correlate the parking lot data 124 with the POI data 118 to create correlation data 126 that identifies which parking lots appear to be serving which POIs. In this way, the correlation data 126 may identify in which parking lot visitors park to access a particular POI (e.g., a particular shopping mall, a particular retailer, a particular landmark, or the like).

Thus, a server may receive aerial data that has been crudely annotated to identify parking lots and determine parking lot data that includes information related to each parking lot, such as the size of each parking lot, a location of each parking lot, and the like. The server may predict, using correlation, which parking lots are used by users visiting a particular POI. For example, the server may predict that users visiting a particular retailer are likely to park in a particular parking lot.

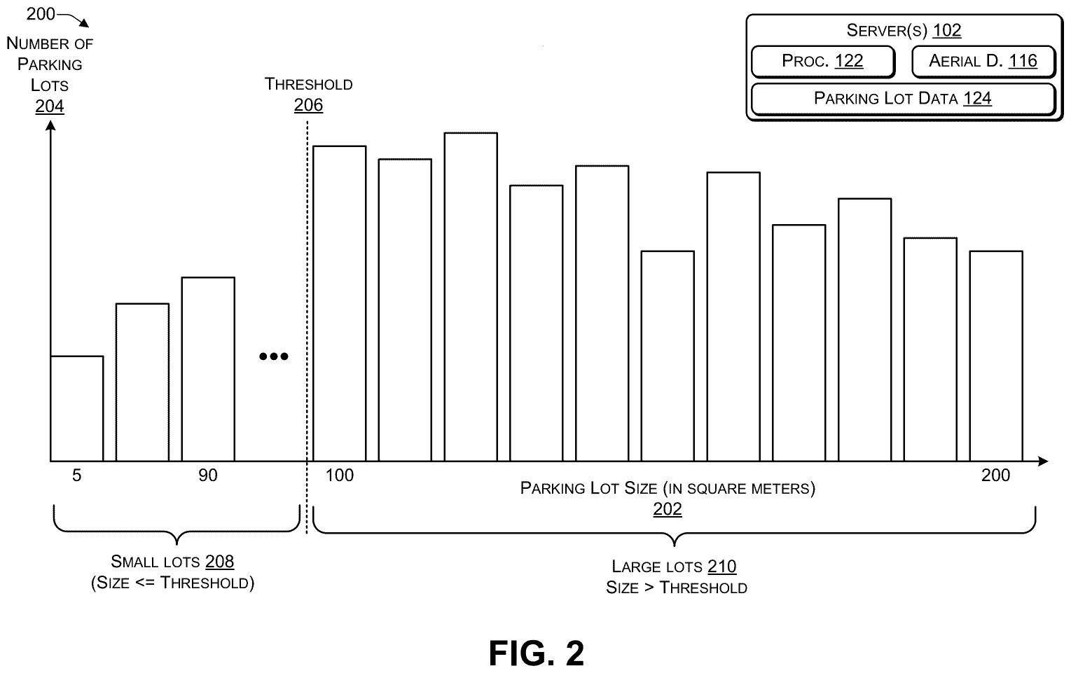

FIG. 2 is a diagram illustrating a parking lot size distribution graph 200, according to some embodiments. After the processing 122 identifies and improves an accuracy of the shape of parking lots in the aerial data 116, the processing 122 may determine a size (e.g., in square meters) of each parking lot and create the parking lot size distribution graph 200, in which a parking lot size 202 is along an x-axis and a number of parking lots 204 is along a y-axis of the graph 200.

While a single processing 122 is illustrated, it should be understood that the processing 122 may include multiple algorithms, with each algorithm designed for a specific purpose. For example, a first algorithm may identify parking lots in the aerial data 116. A second algorithm may analyze large parking lots 210 (e.g., greater than a size threshold 206) to determine if a large parking lot includes multiple smaller parking lots that are in close proximity. For example, the second algorithm may analyze large parking lots 210 (e.g., size greater than the threshold 206) and determine if multiple smaller parking lots were incorrectly joined together as a large parking lot. A third algorithm may analyze small lots 208 (e.g., less than or equal to the size threshold 206) to determine if two or more of the small lots 208 that are in close proximity are a single, large parking lot, and so on. The third algorithm may determine that multiple polygons associated with multiple parking lots are in reality a single parking lot and merge the polygons together into a single geometry.

The graph 200 illustrates using the threshold 206 of 100 square meters for a single parking lot, which can host a maximum of six cars. Such a threshold filters out small, individual parking lots that may have been erroneously identified as separate parking lots but are actually part of a larger geometry. Of course, based on various factors including the average vehicle size, the average parking lot size, and the like, the threshold 206 may be greater than or less than 100 square meters. For example, in countries (e.g., Japan) in which small vehicles are common, a threshold less than 100 square meters may be used. As another example, in cities or counties (e.g., Dallas or Houston) with larger than average vehicle sizes (e.g., because vehicles are predominately large trucks or sport utility vehicles (SUVs)), a threshold greater than 100 meters may be used.

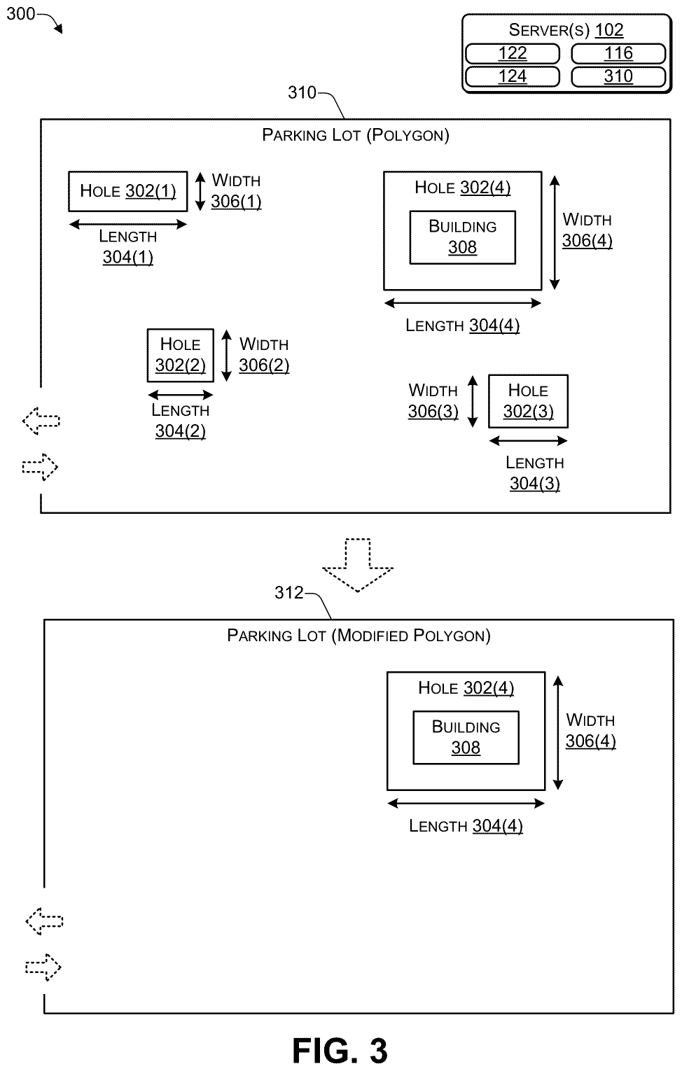

FIG. 3 is a block diagram 300 illustrating identifying and removing particular holes from a parking lot 300, according to some embodiments. The parking lot 300 may include multiple holes in the aerial data 116, such as, for example, a hole 302(1) having a length 304(1) and a width 306(1), a hole 302(2) having a length 304(2) and a width 306(2), a hole 302(3) having a length 304(3) and a width 306(3), and a hole 302(4) having a length 304(4) and a width 306(4). Of course, each parking lot in the aerial data 116 may include zero or more holes and the four holes in FIG. 3 are purely for illustration purposes.

In some cases, the aerial data 116 may incorrectly show holes (e.g., holes 302(1), 302(2), 302(3)) in a parking lot having a 2D polygon 310, resulting in a polygon with holes. The holes 302(1), 302(2), 302(3) may be fitted with 2D polygons in the aerial data 116 because the annotations in the aerial data 116 are relatively crude (e.g., not 100% accurate). For example, the holes 302(1), 302(2), 302(3) in the 2D polygon 302 may be due to (i) vehicles parked in the parking lot, (ii) where a tree forms a shadow in the aerial data 116, (iii) a building, such as a building 308 (e.g., apartment building, office building, or the like) located inside the polygon 310, or the like. In such cases, the aerial data 116 may incorrectly place a 2D polygon to show a small hole (e.g., due to a parked car or shadow of a tree) but correctly place a 2D polygon to show a large hole (e.g., in which a building is located).

To account for such errors, the processing 122 may determine a size (e.g., size=(length 304)×(width 306)) of each hole 302 in the parking lot polygon 300 and remove the holes 302 (e.g., 302(1), 302(2), and 302(3)) that are less than a size threshold 310 to create a modified polygon 312. In this way, the parking lot data 124 includes spatially correct holes, such as, for example, the hole 302(4) indicating the building 308 that is located in the parking lot 300 while excluding the incorrectly shown holes 302(1), 302(2), and 302(3).

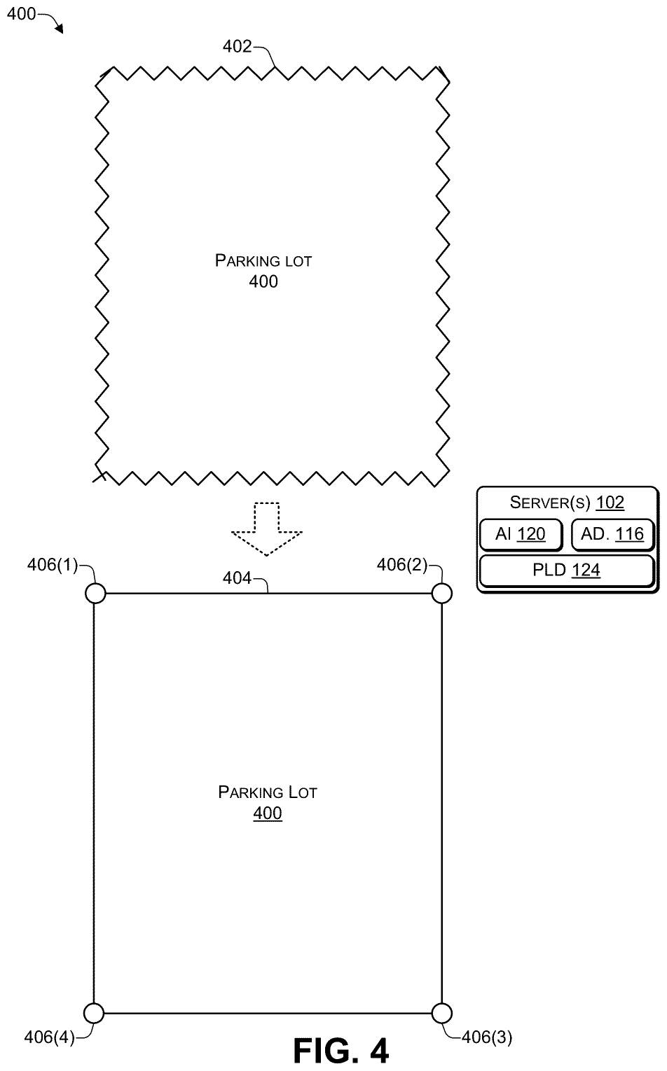

FIG. 4 is a block diagram 400 illustrating smoothing an outline of a parking lot, according to some embodiments. When a data vendor (e.g., the data vendor 109 of FIG. 1) fits a two-dimensional (2D) polygon to a parking lot, such as a representative parking lot 400, the parking lot 400 in the aerial data may include jagged lines between at least some of the coordinates, resulting in a jagged-edge polygon 402 in which one or more edges may be jagged.

The processing 122 may smooth one or more jagged edges of the polygon 402 by drawing a straight line for each edge using two points at the end of each edge (e.g., edge endpoints) to delineate each side of a polygon, resulting in a smooth-edge polygon 404. The processing 122 may draw a straight line between pairs of edge endpoints (point1, point2), such as, for example, between one or more pairs of endpoints (i) (406(1), 406(2)), (ii) (406(2), 406(3)), (iii) (406(3), 406(4)), (iv) (406(4), 406(1)), or any combination thereof.

By simplifying the polygon edge geometry, the resulting polygons have smoother edges, thereby enabling clients to more easily consume, process, transfer and visualize the parking lot data 124.

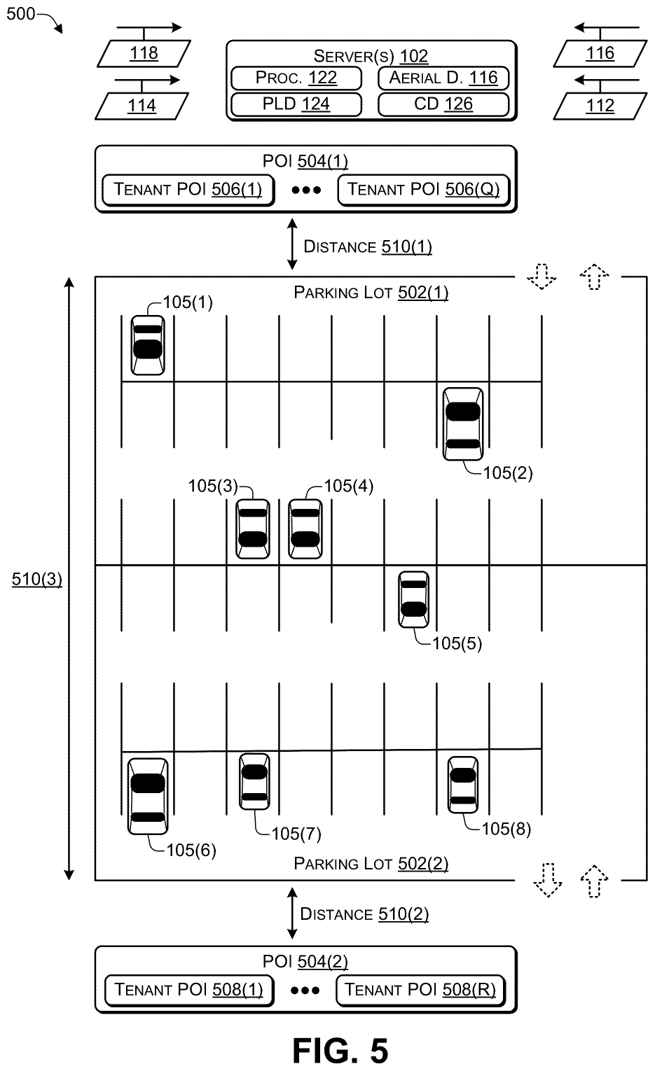

FIG. 5 is a block diagram 500 illustrating parking lots serving more than one point-of-interest (POI), according to some embodiments, according to some embodiments. FIG. 5 includes a parking lot 502(1) that is determined to primarily serve a POI 504(1) and a parking lot 502(2) that that is determined to primarily serve a POI 504(2). When creating the correlation data 126, the processing 122 may determine a distance between a POI and nearby (e.g., less than a predetermined distance) parking lots. For example, the processing 122 may determine a distance 510(1) between the POI 504(1) and the parking lot 502(1), a distance 510(2) between the POI 504(2) and the parking lot 502(2), a distance 510(3) between POI 505(1) and parking lot 502(2), and a distance 510(3) between POI 504(2) and parking lot 502(1). Thus, the correlation data 126 identifying which parking lots are predicted to service which POI may be determined based on the distances 510. For example, the correlation data 126 may indicate that the parking lot 502(1) is the primary parking lot, while parking lot 502(2) is a second parking lot, that service POI 504(1). The correlation data 126 may indicate that the parking lot 502(2) is the primary parking lot, while parking lot 502(1) is a second parking lot, that service POI 504(2).

Each POI 504 may include tenant POIs (sub-POIs). For example, the POI 504(1) may include tenant POIs 506(1) to 506(Q) (Q>0) and the POI 504(2) may include POIs 508(1) to 508(R) (R>0). To illustrate, if the POI 504(1) is a shopping mall, then the tenant POIs 506 may be tenants located in (or near) the POI 504(1). As another illustration, if the POI 504(2) is a park, then the tenant POIs 508 may include points of interest in the park, such as a sculpture or other outdoor-based art work, a lookout point (e.g., with a scenic view), a water feature (e.g., fountain(s)), a food provider (e.g., food truck or the like), or any combination thereof.

The POI 504(1), 504(2) may be used by a client, to correlate mobile device data 112 of FIG. 1, the vehicle device data 114, the parking lot data 124, or any combination thereof to further determine which parking lots are used when people visit a particular POI. The processing 122 may analyze the aerial data 116 to determine the parking lot data 124. The client devices 106 may receive the vehicle device data 114 from individual ones of the vehicle devices 105 (e.g., 105(1), 105(2), 105(3), 105(4), 105(6), 105(7), 105(8)), receive the mobile device data 112 from individual ones of the mobile devices 104(1) to 104(X), 104(X+1) to 104(Y) (1<X<Y<N) and determine which of the mobile devices 104 are associated with which of the vehicle devices 105. For example, prior to the vehicles associated with the vehicle devices 105 being parked, a set of (one or more) of the mobile devices 104 may have a location that moves in synchronization with a particular one of the vehicle devices 105. To illustrate, if mobile devices 104(1) and 104(2) have a location that changes according to (e.g., is in synch with) a location of the vehicle device 105(1), then the client devices 106 may determine that the mobile devices 104(1), 104(2) belong to occupants of a vehicle associated with the vehicle device 105(1). In this way, the client devices 106 may determine which mobile devices 104 arrived in which vehicles.

The client devices 106 may receive the vehicle device data 114 from individual ones of the vehicle devices 105 (e.g., 105(1), 105(2), 105(3), 105(4), 105(6), 105(7), 105(8)). After determining that the vehicle device data 114 indicates that the corresponding vehicle is stationary (e.g., based on determining that a location of the corresponding vehicle has not changed for more than a predetermined period of time), the client devices 106 may correlate a location of each vehicle (e.g., based on location information included in the vehicle device data 114) with the parking lot data 124 to determine in which parking lot each vehicle is located (e.g., parked).

The client devices 106 may receive the mobile device data 112 from individual ones of the mobile devices 104(1) to 104(Y) (1<X<Y<N). The processing 122 may determine a location of each of the mobile devices 102 (e.g., based on location information included in the mobile device data 112) and correlate the location of each mobile device 104 with the POI data 118 to determine which mobile devices 104 are located near each of the POI 504. For example, the client devices 106 may determine that the mobile devices 104(1) to 104(X) are located near the POI 504(1) and that the mobile devices 104(X+1) to 104(Y) are located near the POI 504(2).

The client devices 106 may correlate the data gathered to make determinations regarding where people are parking prior to visiting a particular POI. For example, the client devices 106 may determine that the occupants of vehicles associated with the vehicle devices 105(1), 105(2), 105(3), and 105(4) and having mobile devices 104(1) to 104(X) parked in parking lot 502(1) and are visiting POI 504(1). The processing 122 may determine that the occupants of vehicles associated with the vehicle devices 105(5), 105(6), 105(7), and 105(8) and having mobile devices 104(X+1) to 104(Y) are parked in parking lot 502(2) and visiting POI 504(2).

If the client devices 106 determines that one or more people visiting the POI 504(2) are parking in parking lot 502(1), then the POI 504(2) may advertise this information, e.g., “If parking lot 502(2) is full, please park in parking lot 502(1)”, or “If coming from the south, parking lot 502(2) may be the easiest in which to park and if coming from the north, parking lot 502(1) may be the easiest in which to park”. In this way, the parking lot data 124 and the correlation data 126 may be used to assist visitors to a particular POI in finding parking.

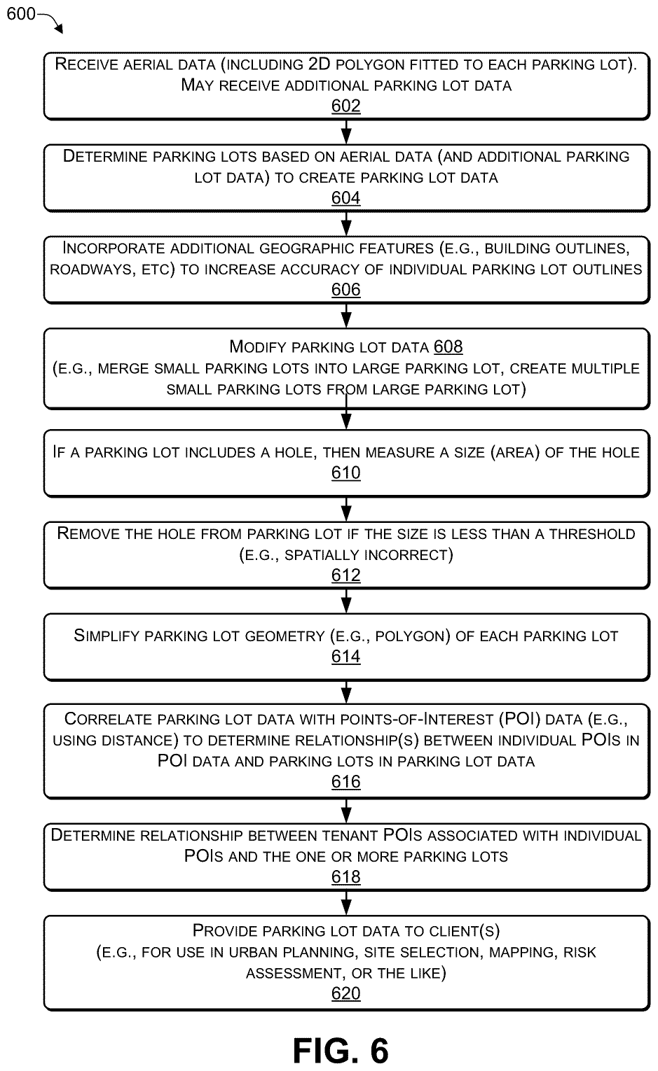

In the flow diagrams of FIGS. 6, 7, 8, and 9 each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the processes 600, 700, 800, and 900 are described with reference to FIGS. 1, 2, 3 and 4 as described above, although other models, frameworks, systems and environments may be used to implement these processes.

FIG. 6 is a flowchart of a process 600 that includes correlating parking lot data with points-of-interest data, according to some embodiments. The process 600 may be performed by the server 102 of FIGS. 1, 2, 3, 4, and 5.

At 602, the process may receive aerial data that includes two-dimensional (2D) polygons fitted to each parking lot. In some cases, the process may receive additional parking lot data (e.g., providing additional information about the parking lots included in the aerial data). At 604, the process may identify parking lots based on the aerial data (and the additional parking lot data) to create parking lot data. At 606, the process may incorporate additional geographic features, such as building outlines, roadways, and the like, to increase an accuracy of an outline of individual parking lots. For example, in FIG. 1, the server 102 may receive the aerial data 116 from the data vendor 109. In some cases, the server 102 may receive the additional data 117 from the additional data vendors 111. The server 102 may perform the processing 122 to identify and refine the parking lot information in the aerial data 116 to create the parking lot data 124. The processing 122 may include using additional geographic features (e.g., included in the additional data 117), such as building outlines, roadways, and the like, to increase an accuracy of an outline of individual parking lots in the parking lot data 124. In this way, the 2D polygon outline of a parking lot may be modified to create a modified polygon that more closely match the outline of the actual parking lot.

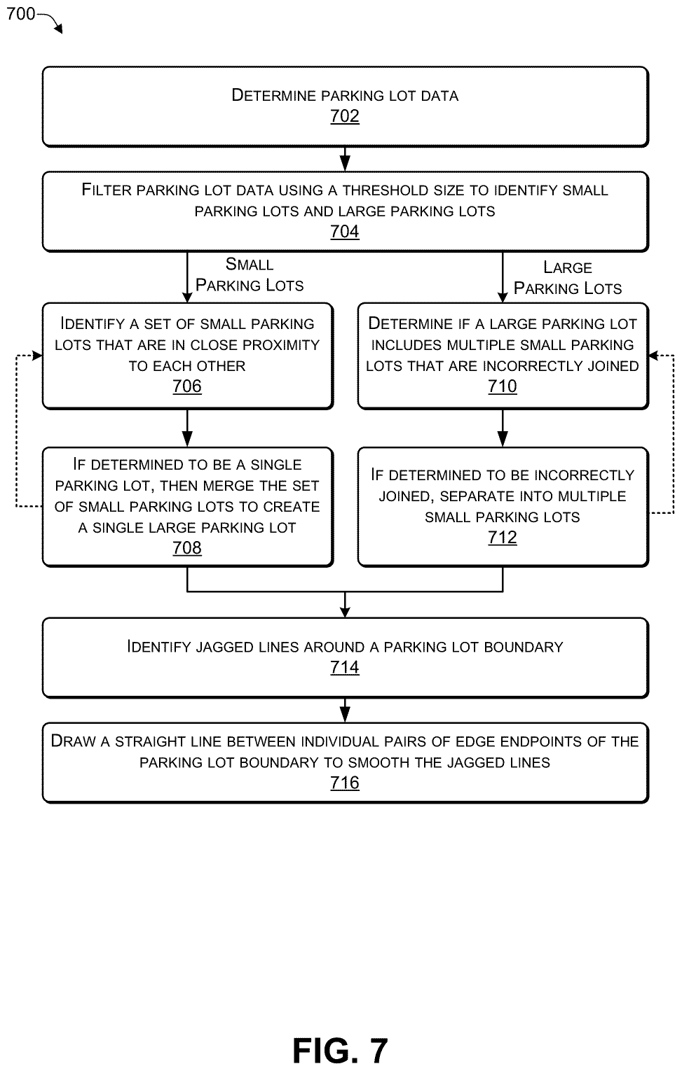

At 608, the process may modify the parking lot data based on a size of individual parking lots. For example, in FIG. 2 (and described further in FIG. 7), the process may identify the small lots 208 and, if the process determines that a set of small lots are part of one large lot, the process may merge the small lots into one large lot and modify the parking lot data 124 accordingly. The process may identify the large lots 210 and, if the process determines that one large lot is comprised of multiple small lots, the process may change the parking lot from one large lot to multiple small lots and modify the parking lot data 124 accordingly.

At 610, if a parking lot includes a hole, then the process may measure a size (e.g., area) of the hole. At 612, the process may remove the hole from the parking lot if the size of the hole is less than a threshold (e.g., the hole is spatially incorrect). For example, in FIG. 3, the process may determine a size (using the length 304 and the width 306) of each hole 302 in the polygon 300 that is fitted to the parking lot and remove holes (e.g., holes 302(1), 302(2), 302(3)) that are less than or equal to a particular threshold while retaining holes larger than the particular threshold, such as the hole 302(4) that includes the building 308. For example, the holes 302(1), 302(2), 302(3) may be determined to be spatially incorrect, e.g., too small to be a parking spot, incorrectly positioned, or the like and removed from the individual parking lot in the parking lot data 124. To illustrate, such holes may be caused by shadows of trees or other landscaping.

At 614, the process may simplify a parking lot geometry (e.g., 2D polygon) of each parking lot to refine individual parking lots in the parking lot data. For example, in FIG. 4, the process may fit a straight line between one or more pairs of edge endpoints of each polygon of the parking lot 300 with jagged edges 402 to simplify the geometry (e.g., 404) when creating the parking lot data 124.

At 616, the process may correlate the parking lot data with POI data to determine relationships between a POI in the POI data and one or more parking lots in the parking lot data. At 618, the process may determine relationships between tenant POIs and parking lots (e.g., based on a relationship between a POI associated with the tenant POIs). For example, in FIG. 5, the server 102 may correlate the parking lots 502 with the POIs 504 based in part on the distance 510 from individual parking lots 502 to the individual POIs 504. Based on these correlations, the server 102 may further correlate the individual tenants 506, 508 to the parking lots 502.

At 620, the process may provide the parking lot data to one or more clients to perform urban planning, site selection, mapping, risk assessment, or other actions. The parking lot data 124 may be used for urban planning, site selection, mapping, risk assessment, or other related actions. For example, in urban planning, if a builder proposes to build a mall for multiple retailers, the parking lot data may be used to determine whether there is sufficient parking in nearby parking lots to support the multiple retailers. As another example, a retailer looking for a site in which to open a store may look at how much parking is available in nearby parking lots and base site selection, at least in part, on parking available near the site.

Thus, a server may receive aerial data, e.g., aerial images fitted with 2D polygons identifying parking lots in the aerial images. The server may refine the outline of the parking lots in the aerial data. The server may filter the parking lot data to identify small parking lots less than or equal to a threshold size and large parking lots greater than the threshold size. The server may (1) identify smaller parking lots that are part of a single larger parking lot and (2) identify a large parking lot that consists of multiple smaller parking lots that are in close proximity to each other. One or more of the 2D polygons fitted to a parking lot may include a hole caused by, for example, a parked car, a shadow of a tree, or the like. The server may identify and discard holes smaller in area (e.g., area=length×width) than a threshold amount while retaining holes larger than the threshold amount that may, for example, include a building. The server may simplify a geometry of each polygon by identifying jagged lines caused by including unnecessary coordinates and drawing a straight line between each pair of edge endpoints of the parking lot boundary to smooth the jagged lines, thereby resulting in a simplified parking lot geometry. The parking lot data may be correlated with points of interest data to determine relationships between a particular point of interest in the POI data and one or more parking lots in the parking lot data. For example, the correlation may identify which parking lots are used by people going to visit a particular POI. The correlation between parking lots and POIs may be extended to tenant POIs of individual POIs. For example, parking lots correlated with a shopping mall may also be correlated to tenants of the shopping mall and to vendors (e.g., restaurants, stores, or the like) located in the parking lot (but outside the mall). As another example, parking lots correlated to a tourist POI (e.g., a park) may be extended to smaller POIs (e.g., restaurant, gift shop, monument, lookout, or the like) located in or near the tourist POI.

FIG. 7 is a flowchart of a process 700 that includes filtering parking lot data, according to some embodiments. The process 700 may be performed by the server 102 of FIGS. 1, 2, 3, 4, and 5.

At 702, the process may determine parking lot data. For example, in FIG. 1, the server 102 may receive the aerial data 116 that includes 2D polygons fitted to each parking lot to crudely identify parking lots in the aerial data 116.

At 704, the process may filter the parking lot data using a threshold size to identify small parking lots and large parking lots. At 706, the process may identify a set of small parking lots that are in close proximity to each other (e.g., a first parking lot is adjacent to at least a second parking lot). At 708, if the process determines that the set of small parking lots are actually a single large parking lot, then the process may merge the first set of small parking lots to create a single large parking lot (in the parking lot data). For example, in FIG. 2, the process may determine the small lots 208 based on the parking lot size 202 being less than or equal to the threshold 206. The process may determine a set of the small parking lots that are in close proximity to each other and, using AI, determine whether the set of small parking lots is in fact a large parking lot that has been erroneously identified (e.g., due to landscaping, geography, layout, or the like) as being a set of small parking lots. If the large parking lot was erroneously identified as being a set of small parking lot, the AI may merge the set of small parking lots into a single large parking lot in the parking lot data. In some cases, 706 and 708 may be repeated until at least a large portion of the small parking lots in the parking lot data that are in close proximity to each other have been examined.

At 710, the process may determine if a large parking lot includes multiple small parking lots that are incorrectly joined together. At 712, if the process determines the multiple small parking lots to be incorrectly joined, then the process may separate the large parking lot into multiple small parking lots. For example, in FIG. 2, after identifying the small lots 208, the process may determine that the remaining parking lots are large parking lots 210 and determine whether any of the large parking lots 210 are actually multiple small parking lots that are incorrectly joined together. If the process determines that a large parking lot is actually multiple small parking lots that have been incorrectly joined together, then the process may separate the particular parking lot into the multiple small parking lots (in the parking lot data). In some cases, 710 and 712 may be repeated until the large parking lots in the parking lot data have been examined.

At 714, the process may identify jagged lines around the parking lot boundary. At 716, the process may draw a straight line between one or more pairs of edge endpoints of the parking lot boundary to smooth the jagged lines. For example, in FIG. 4, the jagged-edged polygon 402 representation of the parking lot 300 may be smoothed to create the smooth-edged polygon 404 representation of the parking lot 300 by drawing a straight line between one or more pairs of edge endpoints (e.g., edge endpoints (406(1), 406(2)), (406(2), 406(3)), (406(3), 406(4)), and (406(4), 406(1)) to create smooth edges for the polygon representation of the parking lot. The jagged-edge polygon 402 may be caused by the data vendor 109 fitting orthogonal lines around the edge of individual parking lots, resulting in crude, jagged edges.

Thus, aerial data received or retrieved from aerial capture devices may be cleaned up (e.g., refined) by identifying smaller parking lots that are actually part of a large parking lot and by identifying multiple small parking lots that have been erroneously identified as a single large parking lot. In this way, the parking lot data is kept accurate with regards to large and small parking lots.

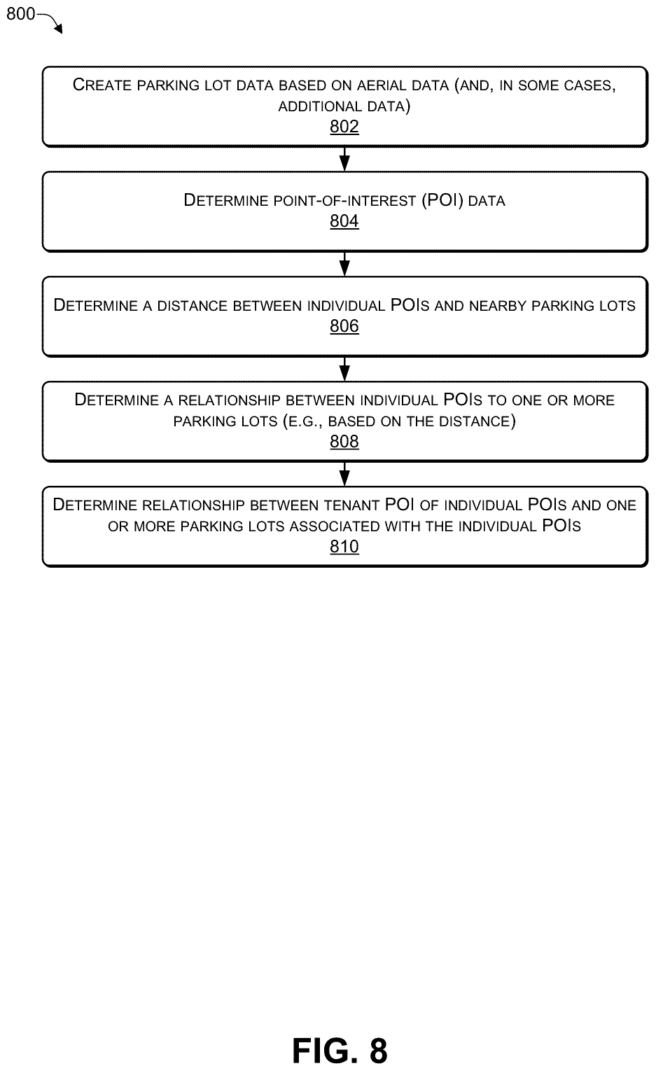

FIG. 8 is a flowchart of a process 800 that includes determining a relationship between individual points-of-interest (POIs) to one or more parking lots, according to some embodiments. The process 800 may be performed by the server 102 of FIGS. 1, 2, 3, 4, and 5.

At 802, the process may create parking lot data based on aerial data (and in some cases additional data). At 804, the process may determine point of interest data. For example, in FIG. 1, the server 102 may receive the aerial data 116 that includes two-dimensional polygons fitted to the parking lots in the aerial images and use the aerial data to create the parking lot data 124. In some cases, the server 102 may receive the additional data 117 from the additional data vendors 111 and use the additional data 117 to further refine the accuracy of the parking lot data 124. For example, the server 102 may correlate the parking lot data derived from the aerial data 116 with the additional data 117 to create more accurate parking lot information in the parking lot data 124. The server 102 may receive the point of interest data 118 from the point of interest database 110.

At 806, the process may determine a distance between individual points of interest in nearby parking lots. At 808, the process may determine a relationship between individual points of interest to one or more parking lots based on the distance. At 810, the process may determine a relationship between tenants of individual points of interest and one or more parking lots associated with the individual points of interest. For example, in FIG. 5, the server 102 may determine the distances 510(1), 510(2), 510(3) between the point of interests 504(1), 504(2) and the parking lots 502(1), 502(2) and determine a relationship between the individual points of interest 504 and the parking lots 502. For example, people visiting a relatively small POI or tenant POI, such as a coffee shop or restaurant, may park relatively close to the POI or tenant POI to reduce the distance they walk from their vehicle to the POI or tenant POI. In contrast, people visiting a large POI, such as an amusement park (e.g., Disneyland®, Disneyworld®, Six Flags®, or the like), may be prepared to walk a longer distance from their vehicle to the POI.

In some cases, the server 102 may take into account time of day (e.g., people parking around lunch time to visit a POI such as a restaurant), seasonality (e.g., day of the week, day of the month, seasonal periods, and the like) when determining the relationship between the individual points of interest 504 and the parking lots 502. For example, during times of day or seasonal periods (e.g., Black Friday), the parking lot 502(1) may be busy (e.g., full or almost full) resulting in some visitors using the parking lot 502(2) when visiting the point of interest 504(1). The server 102 may extrapolate the relationship between the point of interests 504 and the parking lots 502 to the tenants 506 and 508. For example, the relationship between the point of interest 504(1) and the parking lots 502(1), 502(2) may be extrapolated to include the tenants 506(1) to 506(Q).

Thus, a server may create parking lot data based on aerial data, and in some cases additional data. The server may correlate the parking lot data with POI data based on a distance between a particular POI and one or more parking lots to determine a relationship between individual POIs and nearby parking lots. The server may extend the relationship to include tenants of individual POIs.

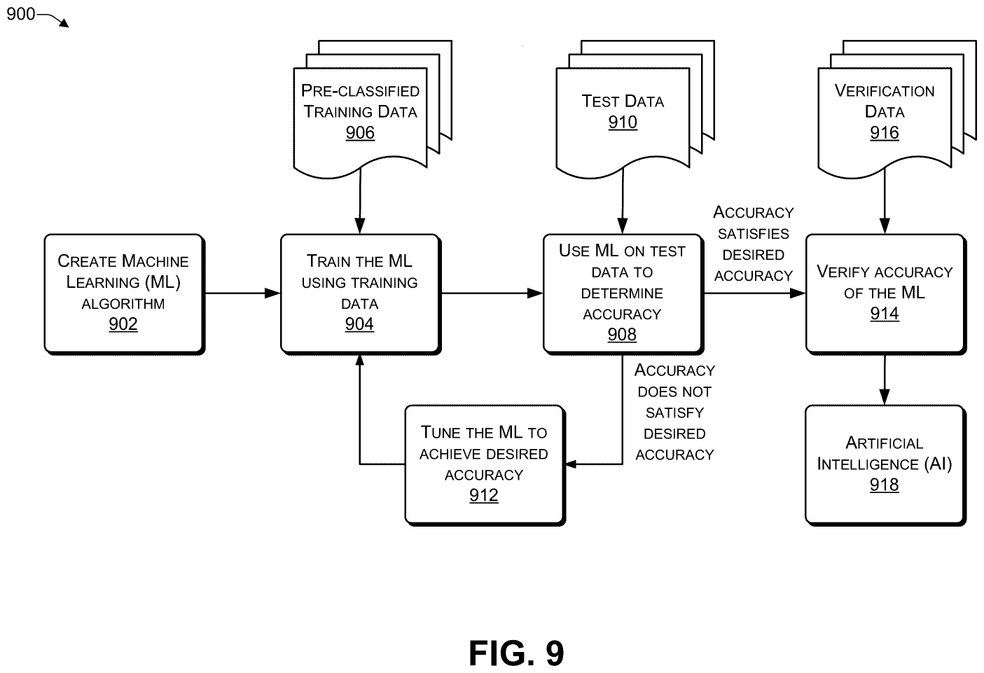

FIG. 9 is a flowchart of a process 900 to train a machine learning algorithm to create an artificial intelligence (e.g., the processing 122 of FIGS. 1, 2, 3, 4, and 5), according to some embodiments. The process 900 may be performed by a server, such as the server 102 of FIGS. 1, 2, 3, 4, and 5.

At 902, the machine learning algorithm (e.g., software code) may be created by one or more software designers. At 904, the machine learning algorithm may be trained using pre-classified training data 906 (e.g., aerial data that has been previously analyzed to identify parking lots in the aerial data). For example, the training data 906 may have been pre-classified by humans, by machine learning, or a combination of both. After the machine learning has been trained using the pre-classified training data 906, the machine learning may be tested, at 908, using test data 910 to determine an accuracy of the machine learning. For example, in the case of a classifier (e.g., support vector machine), the accuracy of the classification may be determined using the test data 910.

If an accuracy of the machine learning does not satisfy a desired accuracy (e.g., 95%, 98%, 99% accurate), at 908, then the machine learning code may be tuned, at 912, to achieve the desired accuracy. For example, at 912, the software designers may modify the machine learning software code to improve the accuracy of the machine learning algorithm. After the machine learning has been tuned, at 912, the machine learning may be retrained, at 904, using the pre-classified training data 906. In this way, 904, 908, 912 may be repeated until the machine learning is able to classify the test data 910 with the desired accuracy.

After determining, at 908, that an accuracy of the machine learning satisfies the desired accuracy, the process may proceed to 914, where verification data 916 may be used to verify an accuracy of the machine learning. After the accuracy of the machine learning is verified, at 914, the machine learning, which has been trained to provide a particular level of accuracy may be used, as artificial intelligence (AI) 918. In some cases, the processing 122 may include the AI 918.

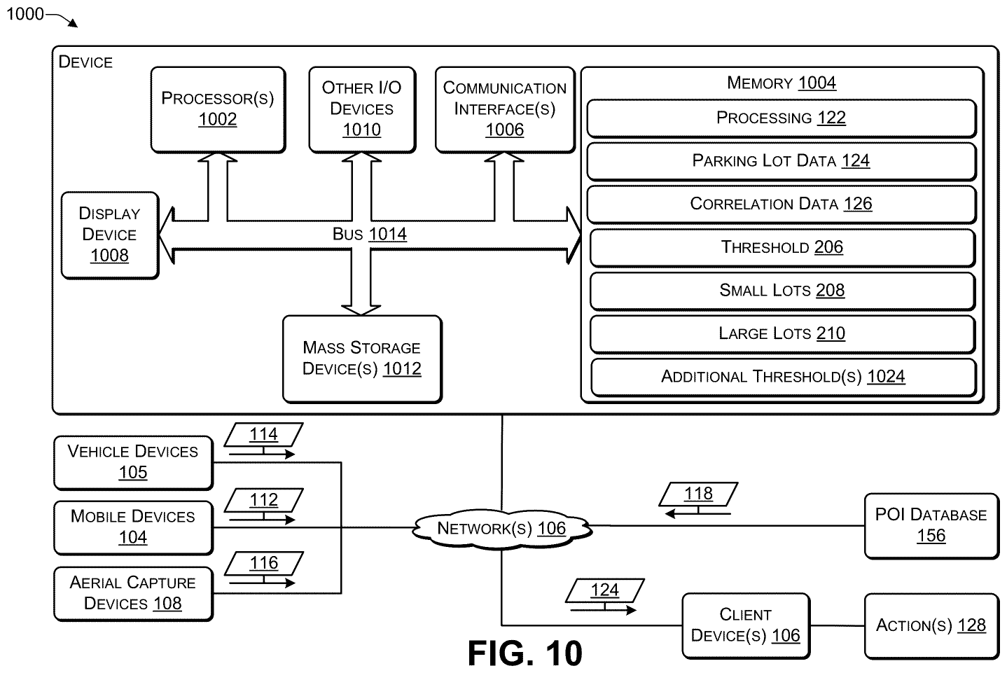

FIG. 10 illustrates an example configuration of a device 1000 that can be used to implement the systems and techniques described herein, such as for example, the server 102 of FIGS. 1, 2, 3, 4, and 5.

The device 1000 may include one or more processors 1002 (e.g., CPU, GPU, or the like), a memory 1004, communication interfaces 1006, a display device 1008, other input/output (I/O) devices 1010 (e.g., keyboard, trackball, and the like), and one or more mass storage devices 1012 (e.g., disk drive, solid state disk drive, or the like), configured to communicate with each other, such as via one or more system buses 1014 or other suitable connections. While a single system bus 1014 is illustrated for ease of understanding, it should be understood that the system buses 1014 may include multiple buses, such as a memory device bus, a storage device bus (e.g., serial ATA (SATA) and the like), data buses (e.g., universal serial bus (USB) and the like), video signal buses (e.g., ThunderBolt®, DVI, HDMI, and the like), power buses, etc.

The processors 1002 are one or more hardware devices that may include a single processing unit or a number of processing units, all of which may include single or multiple computing units or multiple cores. The processors 1002 may include a graphics processing unit (GPU) that is integrated into the CPU or the GPU may be a separate processor device from the CPU. The processors 1002 may be implemented as one or more microprocessors, microcomputers, microcontrollers, digital signal processors, central processing units, graphics processing units, state machines, logic circuitries, and/or any devices that manipulate signals based on operational instructions. Among other capabilities, the processors 1002 may be configured to fetch and execute computer-readable instructions stored in the memory 1004, mass storage devices 1012, or other computer-readable media.

Memory 1004 and mass storage devices 1012 are examples of computer storage media (e.g., memory storage devices) for storing instructions that can be executed by the processors 1002 to perform the various functions described herein. For example, memory 1004 may include both volatile memory and non-volatile memory (e.g., RAM, ROM, or the like) devices. Further, mass storage devices 1012 may include hard disk drives, solid-state drives, removable media, including external and removable drives, memory cards, flash memory, floppy disks, optical disks (e.g., CD, DVD), a storage array, a network attached storage, a storage area network, or the like. Both memory 1004 and mass storage devices 1012 may be collectively referred to as memory or computer storage media herein and may be any type of non-transitory media capable of storing computer-readable, processor-executable program instructions as computer program code that can be executed by the processors 1002 as a particular machine configured for carrying out the operations and functions described in the implementations herein.

The device 1000 may include one or more communication interfaces 1006 for exchanging data via the network 110. The communication interfaces 1006 can facilitate communications within a wide variety of networks and protocol types, including wired networks (e.g., Ethernet, DOCSIS, DSL, Fiber, USB etc.) and wireless networks (e.g., WLAN, GSM, CDMA, 802.11, Bluetooth, Wireless USB, ZigBee, cellular, satellite, etc.), the Internet and the like. Communication interfaces 1006 can also provide communication with external storage, such as a storage array, network attached storage, storage area network, cloud storage, or the like.

The display device 1008 may be used for displaying content (e.g., information and images) to users. Other I/O devices 1010 may be devices that receive various inputs from a user and provide various outputs to the user, and may include a keyboard, a touchpad, a mouse, a printer, audio input/output devices, and so forth.

The computer storage media, such as memory 116 and mass storage devices 1012, may be used to store software and data, including, for example, processing 122, parking data 124, correlation data 126, threshold 206, small lots 208, large lots 210, and additional thresholds 1024 (e.g., distance threshold and other thresholds mentioned herein).

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method comprising:
determining, by one or more processors, a plurality of parking lots in aerial data, the plurality of parking lots identified by a plurality of two-dimensional polygons that correspond to the plurality of parking lots and that are superimposed on aerial images in the aerial data;
simplifying, by the one or more processors, a geometry of the plurality of two-dimensional polygons to create parking lot data;
determining, by the one or more processors, point-of-interest data associated multiple points of interest;
determining, by the one or more processors, correlation data that includes a relationship between:
a particular point-of-interest in the point-of-interest data; and
a set of one or more parking lots in the parking lot data; and
sending, by the one or more processors, the correlation data to a client device to enable the client device to perform:
urban planning,
site selection,
mapping,
risk assessment, or
any combination thereof.

2. The method of claim 1, further comprising:
receiving the aerial data from a data vendor that analyzes aerial images and fits a two-dimensional polygon to individual parking lots included in the aerial images.

3. The method of claim 1, wherein:
determining that the particular point-of-interest is associated with multiple tenants; and
adding additional correlation data to the correlation data that includes a relationship between:
the multiple tenants; and
the set of one or more parking lots associated with the particular point-of-interest.

4. The method of claim 1, wherein:
the correlation data identifies the set of one or more parking lots in the parking lot data that are within a threshold distance from the particular point-of-interest in the point-of-interest data.

5. The method of claim 1, wherein simplifying the geometry of the plurality of two-dimensional polygons comprises:
determining a particular two-dimensional polygon of the plurality of two-dimensional polygons that is fitted to a parking lot boundary;
identifying one or more jagged lines of the particular two-dimensional polygon; and
replacing individual jagged lines of the one or more jagged lines with a straight line drawn between a pair of edge endpoints of each jagged line.

6. The method of claim 1, further comprising:
determining that a particular polygon of the one or more polygons includes a hole;
determining an area of the hole based on a length of the hole and a width of the hole; and
based on determining that the area of the hole is less than or equal to a threshold area, removing the hole from the particular polygon.

7. A server comprising:
one or more processors;
a non-transitory memory device to store instructions executable by the one or more processors to perform operations comprising:
determining a plurality of parking lots in aerial data, the plurality of parking lots identified by a plurality of two-dimensional polygons that correspond to the plurality of parking lots and that are superimposed on aerial images in the aerial data;
simplifying a geometry of the plurality of two-dimensional polygons to create parking lot data;
determining point-of-interest data associated multiple points of interest;
determining correlation data that includes a relationship between:
a particular point-of-interest in the point-of-interest data; and
a set of one or more parking lots in the parking lot data; and
sending the correlation data to a client device to enable the client device to perform:
urban planning,
site selection,
mapping,
risk assessment, or
any combination thereof.

8. The server of claim 7, wherein:
determining that the particular point-of-interest is associated with multiple tenants; and
adding additional correlation data to the correlation data that includes a relationship between:
the multiple tenants; and
the set of one or more parking lots associated with the particular point-of-interest.

9. The server of claim 7, wherein:
the correlation data identifies the set of one or more parking lots in the parking lot data that are within a threshold distance from the particular point-of-interest in the point-of-interest data.

10. The server of claim 7, wherein simplifying the geometry of the plurality of two-dimensional polygons comprises:
determining a particular two-dimensional polygon of the plurality of two-dimensional polygons that is fitted to a parking lot boundary;
identifying one or more jagged lines of the particular two-dimensional polygon; and
replacing individual jagged lines of the one or more jagged lines with a straight line drawn between a pair of edge endpoints of each jagged line.

11. The server of claim 7, the operations further comprising:
determining that a particular polygon of the plurality of two-dimensional polygons includes a hole;
determining an area of the hole based on a length of the hole and a width of the hole; and
based on determining that the area of the hole is less than or equal to a threshold area, removing the hole from the particular polygon.

12. The server of claim 7, the operations further comprising:
based on an analysis of the parking lot data, determining that a plurality of small parking lots in the parking lot data that are in close proximity to each other form part of a large parking lot:
merging individual two-dimensional polygons corresponding to individual small parking lots in the plurality of small parking lots to create the large parking lot;
adding the large parking lot to the parking lot data; and
removing the plurality of small parking lots from the parking lot data.

13. The server of claim 7, the operations further comprising:
based on an analysis of the parking lot data, determining that a large parking lot in the parking lot data comprises a plurality of small parking lots:
separating the large parking lot into the plurality of small parking lots;
removing the large parking lot from the parking lot data; and
adding the plurality of small parking lots to the parking lot data.

14. A non-transitory computer-readable memory device to store instructions executable by one or more processors to perform operations comprising:
determining a plurality of parking lots in aerial data, the plurality of parking lots identified by a plurality of two-dimensional polygons that correspond to the plurality of parking lots and that are superimposed on aerial images in the aerial data;
simplifying a geometry of one or more of the two-dimensional polygons to create parking lot data;
determining point-of-interest data associated multiple points of interest;
determining correlation data that includes a relationship between:
a particular point-of-interest in the point-of-interest data; and
a set of one or more parking lots in the parking lot data; and
sending the correlation data to a client device to enable the client device to perform:
urban planning,
site selection,
mapping,
risk assessment, or
any combination thereof.

15. The non-transitory computer-readable memory device of claim 14, wherein:
determining that the particular point-of-interest is associated with multiple tenants; and
adding additional correlation data to the correlation data that includes a relationship between:
the multiple tenants; and
the set of one or more parking lots associated with the particular point-of-interest.

16. The non-transitory computer-readable memory device of claim 14, wherein:
the correlation data identifies the set of one or more parking lots in the parking lot data that are within a threshold distance from the particular point-of-interest in the point-of-interest data.

17. The non-transitory computer-readable memory device of claim 14, wherein simplifying the geometry of the plurality of two-dimensional polygons comprises:
determining a particular two-dimensional polygon of the plurality of two-dimensional polygons that is fitted to a parking lot boundary;
identifying one or more jagged lines of the particular two-dimensional polygon; and
replacing individual jagged lines of the one or more jagged lines with a straight line drawn between a pair of edge endpoints of each jagged line.

18. The non-transitory computer-readable memory device of claim 14, the operations further comprising:
determining that a particular polygon of the plurality of two-dimensional polygons includes a hole;
determining an area of the hole based on a length of the hole and a width of the hole; and
based on determining that the area of the hole is less than or equal to a threshold area, removing the hole from the particular polygon.

19. The non-transitory computer-readable memory device of claim 14, the operations further comprising:
based on an analysis of the parking lot data, determining that a plurality of small parking lots in the parking lot data that are in close proximity to each other form part of a large parking lot:
merging individual two-dimensional polygons of the plurality of two-dimensional polygons that correspond to individual small parking lots in the plurality of small parking lots to create the large parking lot;
adding the large parking lot to the parking lot data; and
removing the plurality of small parking lots from the parking lot data.

20. The non-transitory computer-readable memory device of claim 14, the operations further comprising:
based on an analysis of the parking lot data, determining that a large parking lot in the parking lot data comprises a plurality of small parking lots:
separating the large parking lot into the plurality of small parking lots;
removing the large parking lot from the parking lot data; and
adding the plurality of small parking lots to the parking lot data.
